(19) United States
(12) Patent Application Publication
(10) Pub. No.: US 2005/0065896 A1
(43) Pub. Date: Mar. 24, 2005

(54) Method and system for automated postage correction of residual mail

(75) Inventors: Robert H. Kummer JR., Southbury, CT (US); Jacques E. Hasbani, Easton, CT (US); Richard Horree, Brookfield, CT (US)

Correspondence Address: Pitney Bowes Inc.;Intellectual Property and Technology Law Dept., 35 Waterview Drive, P.O. Box 3000, Shelton, CT, 06484, US

(73) Assignee: Pitney Bowes Incorporated, Stamford, CT (US)

(21) Appl. No.: 10/665,625

(22) Filed: Sep. 19, 2003

(51) Int. Cl. G06F 17/60; G06F 17/00

(52) U.S. Cl. 705/401

(57) ABSTRACT

The present invention relates to a system and method for processing residual mail to automatically correct the postage therefor. A first class of service that was used to originally process the residual mail and a second class of service to which a postage value originally applied to the residual mail is to be corrected are received. A postage correction table is then generated from a first rate table corresponding to the first class of service and a second rate table corresponding to the second class of service. A postage correction amount for each piece of residual mail is determined based upon the postage correction table. The postage correction table may include a plurality of weight breaks and a plurality of corresponding postage correction rates and/or dimension based charges, and the postage correction amount may be based on a measured weight and/or dimension of each pieces of residual mail.

### FIELD OF THE INVENTION

The invention disclosed herein relates generally to mailing processing systems, and more particularly to a system and method for automatically correcting postage for residual mail.

### BACKGROUND OF THE INVENTION

Mail processing systems, such as, for example, a mailing machine, often include different modules that automate the processes of producing mail pieces. The typical mailing machine includes a variety of different modules or sub-systems, each of which performs a different task on the mail piece. The mail piece is conveyed downstream utilizing a transport mechanism, such as rollers or a belt, to each of the modules. Such modules could include, for example, a singulating module for separating a stack of mail pieces such that the mail pieces are conveyed one at a time along the transport path, a stripping/moistening module for stripping open the flap of an envelope, and wetting and sealing the glued flap of an envelope, a weighing module for weighing the mail piece, and a metering/printing module, for storing postage and applying evidence of postage to the mail piece. The mailing machine is controlled by a central processing unit that executes software that is stored in memory provided in the mailing machine. The exact configuration of the mailing machine is, of course, particular to the needs of the user.

Postal authorities publish postage rate schedules based on a variety of parameters, such as the weight and/or dimensions of the mail piece, the origin and/or destination of the mail piece and the class of mail being used. A mailing machine as described above typically stores a series of tables corresponding to the published rate schedules. In operation, a user weighs a mail piece and selects a class of service for the mail piece and then feeds the mail piece through the mailing machine. The mailing machine determines the proper postage for the mail piece based on the stored tables and the measured weight and chosen class of service and prints the proper postage either directly on the mail piece or on a tape to be applied to the mail piece.

Certain mail processing systems include technology that allows continuous processing of mixed mail, meaning mail pieces having different weights and dimensions, including length, width and thickness, without the need to manually sort the mail based on weight and/or dimension. In such systems, as the mail pieces are conveyed through the system, they are automatically weighed and measured and a postage rate is determined from one or more stored rate tables based on the measured weight and dimensions and a class of service entered by the user. The mail processing system then applies the determined postage to each mail piece, either by printing a postage indicia directly on the mail piece or on a tape to be adhered to the mail piece. Examples of such a mail processing system are the DM Series™ mailing systems sold by the assignee of the present application.

Postal authorities such as the U.S. Postal Service provide postage discounts for mail that is presorted based on delivery destination. In the United States, the discounts increase with the granularity to which the mail is sorted along delivery routes. A first level discount is provided if mail is presorted to the first three digits of the destination zip code, a second level discount, greater than the first, is provided if mail is presorted to the first five digits of the destination zip code, and a third level discount, greater than the first two levels, is provided if mail is presorted to a particular mail carrier's delivery route. In addition, to be eligible for the appropriate discounts, the mail must not only be presorted correctly based on particular delivery destination parameters, but the mail pieces must also fall within certain weight limits and must be of at least a minimum number.

Mailers that wish to take advantage of the available presort discounts must first sort the mail according to one of the presort categories described above. The mail may be sorted manually or through some automatic process, such as through the use of a scanner that reads address information and sorts the mail accordingly. Alternatively, mail may be sorted when each mail piece is generated as in the case of a high volume biller that will generate and group all mail pieces according to particular presort discount categories (e.g., five digit zip code levels) at the same time. Once the mail pieces are presorted to a particular granularity, each presort batch is then processed through a mail processing system such as is described herein. In particular, for each presort batch the applicable class of service, which is based on the presort granularity chosen by the user, is entered into the mail processing system and each mail piece in the presort batch is conveyed through the system where it is weighed and measured and, based on the determined weight and dimensions and using a stored rate table, each mail piece is rated, i.e., a postage amount for each mail piece is determined. The determined postage amount is then applied to each mail piece.

Next, each mail piece that has been so processed must be validated, meaning that each mail piece is checked to determine that it satisfies all of the criteria required for the presort class that was chosen. If a mail piece does not satisfy all of the required criteria, such as not falling within the specified delivery route parameters (e.g., zip code range) or the specified weight or size range, it is rejected. The validation may be done manually or through some automatic process that uses, for example, a scanner to read address information, a scale to weigh the mail piece or a sensor or array of sensors, such as optical sensors, to measure various dimensions of the mail piece. Any mail piece that is not validated, i.e., that is rejected, is referred to as residual mail.

Residual mail is not eligible to receive the postage discount for which it was originally rated. Thus, all residual mail must have its postage corrected. Currently, under U.S. Postal Service regulations, all residual mail must be sent first class as a single piece. Thus, all residual mail must have its postage corrected to first class by having an additional postage amount applied to it that is equal to the difference between the first class postage for the mail piece and the postage that was actually applied to the mail piece when it was originally processed as part of a presorted batch of mail. Under the applicable regulations, the postage correction amount is printed in an indicia that is applied to the backside of the mail piece.

The current method of postage correction involves first sorting the residual mail pieces by weight and size. Then, for each batch of residual mail that has been sorted in this manner, the proper postage correction amount is determined, which is equal to the difference between the first class postage that would be required for a mail piece of the particular weight and size in question and the postage amount that was actually applied to the mail pieces. A mail processing system is then set to apply the determined postage correction amount in a manual postage setting mode that is exclusive of class of service and each of the residual mail pieces in the group are conveyed through the mail processing system, wherein the postage correction amount is applied to each residual mail piece. This process is repeated for each sorted group of residual mail.

Under this current method of postage correction, there is no correction of transaction accounting information that in effect moves each piece of residual mail from the presort category in which it was originally processed and accounts for it in a new category based on the postage corrections process. Thus, the data capture information for the presorted mail that has been processed will be inaccurate to the extent of any residual mail that has been corrected. Also, there is no separate accounting for the residual mail that has been corrected to another class such as first class. Instead, the postage correction amounts are merely attributed to a total postage correction amount category. Thus, there is a need for a system and method that automatically corrects the postage for residual mail and accounts for transaction information for presorted and residual mail accurately.

### SUMMARY OF THE INVENTION

The present invention relates to a method for processing one or more pieces of residual mail to automatically correct the postage for the residual mail and to a system which implements the method. The method includes receiving a first class of service that was used to originally process the residual mail and receiving a second class of service to which a postage value originally applied to each of the pieces of residual mail is to be corrected. Next, a postage correction table is generated from a first rate table corresponding to the first class of service and a second rate table corresponding to the second class of service. A postage correction amount for each of the pieces of residual mail is determined based upon the postage correction table, and the determined postage correction amount is applied to each of the pieces of residual mail.

The postage correction table may, in a particular embodiment, include a plurality of weight breaks and a plurality of corresponding postage correction rates. The postage correction amount in this embodiment is based on the weight of each of the pieces of residual mail. Such a postage correction table may be generated by calculating, for each of the weight breaks to be included therein, a difference between two corresponding rates from the first and second rate tables received from a user. The difference that is calculated for each weight break is the postage correction rate in the postage correction table.

The method of the present invention may also include determining one or more dimensions of each of the pieces of residual mail, wherein the postage correction amount is further based on the measured dimensions. In this embodiment, the postage correction table may include a plurality of weight breaks and a plurality of corresponding postage correction rates and dimension based charges. In this embodiment, the generation of the postage correction table may further include calculating, for each weight break in the postage correction table, a second difference between two corresponding dimension based charges from the first and second rate tables. This second difference is, for each weight break in the postage correction table, the dimension based charge.

In one embodiment, a mail processing system according to the present invention includes a postage meter for applying postage values to one or more pieces of mail, a central processing unit controlling operation of the postage meter, and a memory storing information including a plurality of rate tables and software executable by the central processing unit. In this embodiment, the software includes instructions for executing the method of automatically correcting postage for one or more pieces of residual mail according to the present invention. The mail processing system may further include a scale for weighing each of the pieces of residual mail and a dimensioning module for measuring one or more dimensions of each of the pieces of residual mail.

Therefore, it should now be apparent that the invention substantially achieves all the above aspects and advantages. Additional aspects and advantages of the invention will be set forth in the description that follows, and in part will be obvious from the description, or may be learned by practice of the invention. Moreover, the aspects and advantages of the invention may be realized and obtained by means of the instrumentalities and combinations particularly pointed out in the appended claims.

### DESCRIPTION OF THE DRAWINGS

The accompanying drawings illustrate presently preferred embodiments of the invention, and together with the general description given above and the detailed description given below, serve to explain the principles of the invention. As shown throughout the drawings, like reference numerals designate like or corresponding parts.

FIG. 1 is an isometric view of a mail processing system according to the present invention;

FIG. 2 is a block diagram of the mail processing system of FIG. 1;

FIG. 3 is a flow diagram illustrating a methodology for processing presorted mail that utilizes a system and method for automatic postage correction for residual mail according to the present invention; and

FIG. 4 is a flow diagram illustrating the operation of the mail processing system according to the present invention that automatically corrects postage for residual mail.

### DETAILED DESCRIPTION OF THE PREFERRED EMBODIMENTS

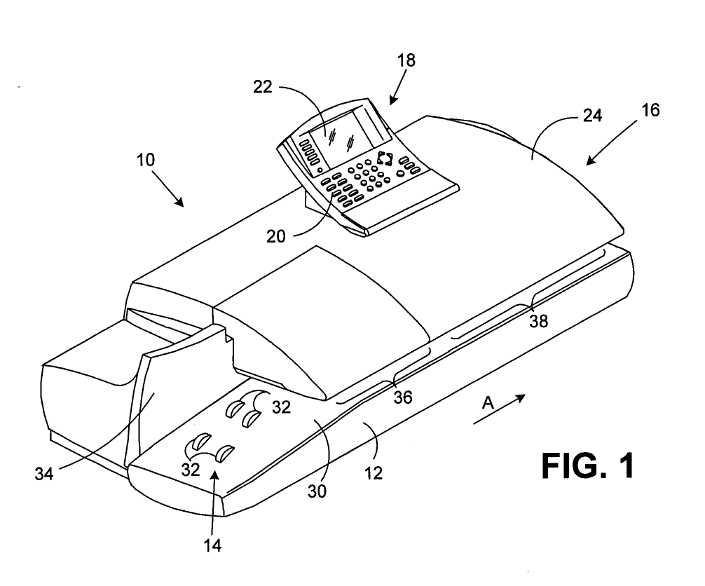

Referring to FIG. 1, an isometric view of a mail processing system 10, such as a mailing machine, according to the present invention is shown. Mailing processing system 10 comprises a base unit, designated generally by the reference numeral 12, the base unit 12 having a mail piece input end, designated generally by the reference numeral 14 and a mail piece output end, designated generally by the reference numeral 16. A UIC 18 is mounted on the base unit 12, and includes one or more input/output devices, such as, for example, a keyboard 20 and a display device 22. One or more cover members 24 are pivotally mounted on the base 12 so as to move from the closed position shown in FIG. 1 to an open position (not shown) so as to expose various operating components and parts for service and/or repair as needed.

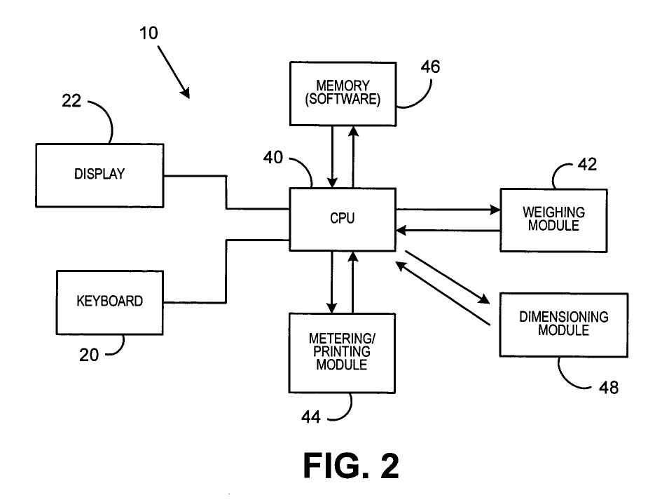

The base unit 12 further includes a horizontal feed deck 30 that extends substantially from the input end 14 to the output end 16. A plurality of nudger rollers 32 are suitably mounted under the feed deck 30 and project upwardly through openings in the feed deck so that the periphery of the rollers 32 is slightly above the upper surface of the feed deck 30 and can exert a forward feeding force on a succession of mail pieces placed in the input end 14. A vertical wall 34 defines a mail piece stacking location from which the mail pieces are fed by the nudger rollers 32 along the feed deck 30 and into a transport system (not shown) that transports the mail pieces in a downstream path of travel, as indicated by arrow A, through one or more modules, such as, for example, a separator module and moistening/sealing module. Each of these modules is located generally in the area indicated by reference numeral 36. The mail pieces are then passed to a weighing module 42 (shown in FIG. 2) and a metering/printing module 44 (shown in FIG. 2) located generally in the area indicated by reference numeral 38, and exit the mailing processing system 10 at the output end 16.

Referring to FIG. 2, a block diagram of mail processing system 10 is shown. Mail processing system 10 includes central processing unit (CPU) 40. Display device 22 and keyboard 20 provide a user interface to CPU 40. Weighing module 42, such as a scale, weighs mail pieces and metering/printing module 44, such as a postage meter, applies postage to the mail pieces and manages postage amounts stored therein. Mail processing system 10 also includes dimensioning module 48 for measuring one or more dimensions of a mail piece such as thickness, width and length. Dimensioning module 48 may take any one of many forms known in the art, and may comprise, for example, an array of sensors, such as optical sensors. Mail processing system 10 is of the type that is able to process mixed mail without the need to manually sort the mail based on weight or dimensions. CPU 40 controls all operations of mail processing system 10 as described herein by executing software stored in memory 46, such as a non-volatile memory module.

Stored within memory 46 is a database of information that includes the standard rate tables published by the relevant postal authorities that specify the postage rates for all classes of mail. Within each class of mail, the rate tables specify a particular postage amount that applies to all mail pieces falling within a particular weight range. Specifically, for each class of mail, the tables will specify a maximum weight, known as a weight break, for each level of postage. The weight breaks may vary for different classes of mail. The rate tables may also specify an additional charge for each weight range that applies if a mail piece meets or exceeds certain dimension parameters. Also stored within memory 46 is a processing engine that provides appropriate access to the data provided in the tables.

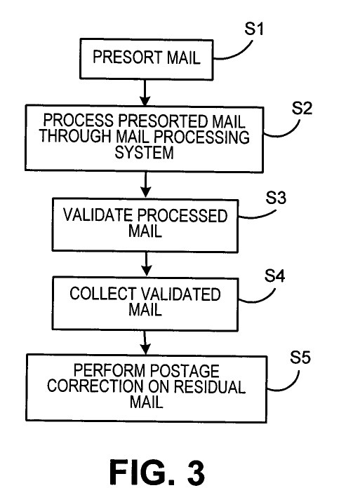

FIG. 3 is a flow diagram illustrating the steps for presorting and processing mail to take advantage of postage discounts that utilizes a system and method for automatically correcting postage on residual mail according to the present invention. At step S1, a user presorts a large batch of mail into smaller batches of mail according to particular granularities of delivery route, e.g., three digit zip code, five digit zip code or zip plus four. At step S2, the user takes one of the presorted batches and processes it through mail processing system 10. Specifically, the user enters the appropriate presort class into mail processing system 10 using keyboard 20 and each mail piece in the batch is weighed using weighing module 42, measured using dimensioning module 48, and rated using the appropriate rate table stored in memory 46 based on the measured weight and dimensions. The appropriate postage is then applied to each mail piece, either directly or to a tape, by metering/printing module 44. During step S2, transaction information for each mail piece, including one or more of weight, dimensions, postage value and class of service, is captured and stored for subsequent reporting to the postal authority. Next, at step S3, each mail piece that has been processed is validated, either manually or automatically, to determine whether it meets the sorting requirements of the chosen class. At step S4, all mail pieces that have been validated are collected and accumulated to meet the minimum piece count required to be eligible for the discount. All mail that is not validated in step S4 is residual mail. At step S5, the postage for the residual mail is corrected using the system and method of the present invention that is described in connection with FIG. 3.

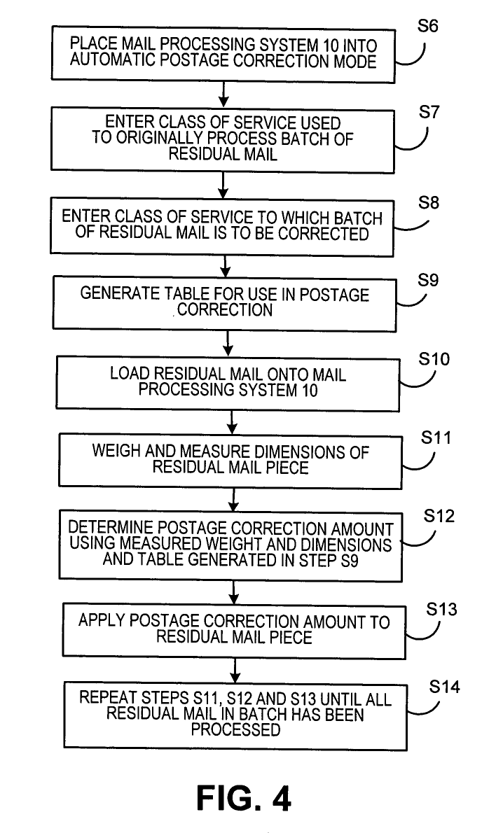

Referring to FIG. 4, a flow diagram is provided that illustrates the operation of mail processing system 10 according to the present invention in which postage for residual mail is automatically corrected. As noted above, operation of mail processing system 10 as described in FIG. 3 is controlled using software that is stored in memory 46 and executed by CPU 40. Referring to step S6, a user first places mail processing system 10 into a mode for performing automatic postage correction for residual mail. This may be done, for example, through use of display 22 and keyboard 20. The automatic postage correction mode utilizes the capabilities of mail processing system 10 to process mixed mail as described above. Next, at step S7, the user enters the class of service that was used in originally processing the batch of residual mail that is now having its postage corrected. At step S8, the user enters the class of service to which the postage for the residual mail is to be corrected. The class of service entered in step S8 may be first class, single piece as is currently required by U.S. Postal Service requirements, or may be some other class of service for which the residual mail meets the requirements. For example, the residual mail may have originally been processed in a five digit zip code class, with the residual mail not falling within the particular five digit class but meeting a broader three digit zip class. In that case, the residual mail could be corrected to the appropriate three digit zip code class. While this type of correction is not currently permitted under U.S. Postal Service regulations, it may be in the future. In addition, this type of correction may be permissible under the regulations of a country other than the United States.

Next, at step S9, mail processing system 10, and specifically CPU 40, processes the database of information including the rate tables stored in memory 46 to generate a new table of weight breaks and corresponding rates for use in the subsequent correction of the postage for the residual mail. Specifically, to generate this rate table, mail processing system 10 first examines the rate table for the class of service entered in step S8 (the class to which the residual mail is to be corrected), and for each weight break provided therein it finds the corresponding or overlapping weight break in the rate table for the class of service entered in step S7 (the class in which the residual mail was originally processed). Next, the difference between the rate for the class of service entered in step S8 and the rate for the class of service entered in step S7 is calculated for each corresponding or overlapping weight break pair. In addition, for each overlapping weight break pair, a second difference is calculated between any dimension based charge applicable to the class entered in step S8 and any dimension based charge applicable to the class entered in step S7. The dimension based charge may be, for example, the charge applied to a mail piece that exceeds a specified dimension such as height, width or thickness. The table that is generated in step S9 thus consists of the weight breaks of the rate table for the class of service entered in step S8 and, for each such weight break, the corresponding difference in rates and dimension based charges that were calculated. In the event that the subtractions described in step S9 result in a negative number, i.e., the postage applied originally to the residual mail piece is greater than what is required in the new class, the postage correction amount in the new table will be set to zero. In other words, no postage is refunded.

To assist in understanding the present invention, the following example is provided. Assume that the class of service entered in step S7 is first class auto letter five digit (i.e., sorting to a specific five digit zip code) and the corresponding rate table stored in memory 46 for this class is as shown in TABLE 1 below.

TABLE 1

| Weight Break | Rate | Oversize Rate |
|---|---|---|
| 1.0 ounces | 0.278 | 0.00 |
| 2.0 ounces | 0.503 | 0.00 |
| 3.0 ounces | 0.687 | 0.00 |
| 3.3 ounces | 0.912 | 0.00 |

Also assume that the class of service that was entered in step S8 is first class regular mail and the corresponding rate table stored in memory 46 for this class is as shown in TABLE 2 below.

TABLE 2

| Weight Break | Rate | Oversize Rate |
|---|---|---|
| 1.0 ounce | 0.37 | +0.12 |
| 2.0 ounces | 0.60 | 0.00 |
| 3.0 ounces | 0.83 | 0.00 |
| 4.0 ounces | 1.06 | 0.00 |
| 5.0 ounces | 1.29 | 0.00 |
| 6.0 ounces | 1.52 | 0.00 |
| 7.0 ounces | 1.75 | 0.00 |
| 8.0 ounces | 1.98 | 0.00 |
| 9.0 ounces | 2.21 | 0.00 |
| 10.0 ounces | 2.44 | 0.00 |
| 11.0 ounces | 2.67 | 0.00 |
| 12.0 ounces | 2.90 | 0.00 |
| 13.0 ounces | 3.13 | 0.00 |

The table that is generated in step S9 for use in postage correction would be as set forth in TABLE 3 below.

TABLE 3

| Weight Break | Rate | Oversize Rate |
|---|---|---|
| 1.0 ounce | 0.092 | +0.12 |
| 2.0 ounces | 0.097 | 0.00 |
| 3.0 ounces | 0.143 | 0.00 |
| 3.3 ounces | 0.148 | 0.00 |
| 4.0 ounces | 1.06 | 0.00 |
| 5.0 ounces | 1.29 | 0.00 |
| 6.0 ounces | 1.52 | 0.00 |
| 7.0 ounces | 1.75 | 0.00 |
| 8.0 ounces | 1.98 | 0.00 |
| 9.0 ounces | 2.21 | 0.00 |
| 10.0 ounces | 2.44 | 0.00 |
| 11.0 ounces | 2.67 | 0.00 |
| 12.0 ounces | 2.90 | 0.00 |
| 13.0 ounces | 3.13 | 0.00 |

Referring to step S10, once the table is generated in step S9, the residual mail is loaded onto mail processing system 10 and is sequentially fed for processing. Preferably, display 22 provides a prompt to the user reminding the user of the required orientation of the mail piece to ensure that a valid postage correction indicia is applied to the mail piece in the correct place, e.g., on the backside thereof. At step S11, the first residual mail piece is weighed by weighing module 42 and measured by dimensioning module 48. Next, at step S12, a postage correction amount is determined based on the measured weight and dimensions and the table generated in step S9. In step S13, the postage correction amount that is determined in step S12 is applied to the residual mail piece and appropriate accounting of the transaction as described below takes place. At step S14, steps S11, S12 and S13 are repeated for each piece of residual mail.

As described above, under the current method of postage correction, the captured transaction information for the presorted mail is not accurate because transaction information for residual mail is not removed from the presort category in which it was originally processed and because no separate accounting is done for the new class to which the residual mail is corrected. According to an aspect of the present invention, these accounting and data capture inaccuracies are compensated for. Specifically, when each piece of residual mail has its postage corrected, its transaction information is removed from any data capture categories in which it was originally placed. Moreover, for each piece of residual mail that is processed to have its postage corrected, accurate transaction information, reflecting the proper (i.e., corrected) class of service, weight, dimensions and/or postage value, is captured and stored for subsequent reporting.

While preferred embodiments of the invention have been described and illustrated above, it should be understood that these are exemplary of the invention and are not to be considered as limiting. Additions, deletions, substitutions, and other modifications can be made without departing from the spirit or scope of the present invention. Accordingly, the invention is not to be considered as limited by the foregoing description but is only limited by the scope of the appended claims.

1. A method of processing one or more pieces of residual mail, comprising:
accessing a first rate table corresponding to a first class of service used to originally process said one or more pieces of residual mail;
accessing a second rate table corresponding to a second class of service to which a postage value originally applied to each of said one or more pieces of residual mail is to be corrected;
generating a postage correction table from said first rate table and said second rate table;
determining a postage correction amount for each of said one or more pieces of residual mail based on said postage correction table; and
applying said determined postage correction amount to each of said one or more pieces of residual mail.

2. A method according to claim 1, further comprising determining a weight of each of said one or more pieces of residual mail, wherein said postage correction amount is based on said weight of each of said one or more pieces of residual mail.

3. A method according to claim 2, further comprising determining one or more dimensions of each of said one or more pieces of residual mail, wherein said postage correction amount is further based on said one or more dimensions of each of said one or more pieces of residual mail.

4. A method according to claim 2, said postage correction table comprising a plurality of weight breaks and a plurality of corresponding postage correction rates.

5. A method according to claim 4, said generating step further comprising calculating, for each of said weight breaks, a difference between a first corresponding rate from said second rate table and a second corresponding rate from said first rate table, said difference being said postage correction rate for said weight break.

6. A method according to claim 3, said postage correction table comprising a plurality of weight breaks and plurality of corresponding postage correction rates and dimension based charges.

7. A method according to claim 6, said generating step further comprising calculating, for each of said weight breaks, a first difference between a first corresponding rate from said second rate table and a second corresponding rate from said first rate table and a second difference between a first corresponding dimension based charge from said second rate table and a second corresponding dimension based charge from said first rate table, said first difference being said postage correction rate for said weight break and said second difference being said dimension based charge for said weight break.

8. A method according to claim 5, said calculating step for each of said weight breaks further comprising setting said postage correction rate equal to zero if said difference is negative.

9. A method according to claim 7, said calculating step for each of said weight breaks further comprising setting said postage correction rate equal to zero if said first difference is negative and setting said dimension based charge equal to zero if said second difference is negative.

10. A mail processing system, comprising:
a metering/printing module for applying postage values to one or more pieces of mail;
a central processing unit controlling operation of said metering/printing module; and
a memory storing information including software executable by said central processing unit, said software including instructions for:
accessing a first rate table corresponding to a first class of service used to originally process one or more pieces of residual mail;
accessing a second rate table corresponding to a second class of service to which a postage value originally applied to each of said one or more pieces of residual mail is to be corrected;
generating a postage correction table from said first rate table and said second rate table;
determining a postage correction amount for each of said one or more pieces of residual mail based on said postage correction table; and
causing said metering/printing module to apply said determined postage correction amount to one of each of said one or more pieces of residual mail or a tape to be applied to said one or more pieces of residual mail.

11. A mail processing system according to claim 10, further comprising a weighing module for weighing one or more mail pieces, said weighing module being controlled by said central processing unit, said software further including instructions for determining a weight for said one or more pieces of residual mail using said weighing module, wherein said postage correction amount is based on said weight of each of said one or more pieces of residual mail.

12. A mail processing system according to claim 11, said postage correction table comprising a plurality of weight breaks and a plurality of corresponding postage correction rates.

13. A mail processing system according to claim 12, said generating instructions further comprising instructions for calculating, for each of said weight breaks, a difference between a first corresponding rate from said second rate table and a second corresponding rate from said first rate table, said difference being said postage correction rate for said weight break.

14. A mail processing system according to claim 11, further comprising a dimensioning module for determining one or more dimensions of a mail piece, said dimensioning module being controlled by said central processing unit, said software further including instructions for determining one or more dimensions for said one or more pieces of residual mail using said dimensioning module, wherein said postage correction amount is further based on said one or more dimensions of each of said one or more pieces of residual mail.

15. A mail processing system according to claim 14, said dimensioning module comprising an array of sensors.

16. A mail processing system according to claim 15, said sensors being optical sensors.

17. A mail processing system according to claim 14, said postage correction table comprising a plurality of weight breaks and plurality of corresponding postage correction rates and dimension based charges.

18. A mail processing system according to claim 17, said generating instructions further comprising instructions for calculating, for each of said weight breaks, a first difference between a first corresponding rate from said second rate table and a second corresponding rate from said first rate table and a second difference between a first corresponding dimension based charge from said second rate table and a second corresponding dimension based charge from said first rate table, said first difference being said postage correction rate for said weight break and said second difference being said dimension based charge for said weight break.

19. A mail processing system according to claim 13, said calculating step for each of said weight breaks further comprising setting said postage correction rate equal to zero if said difference is negative.

20. A mail processing system according to claim 18, said calculating step for each of said weight breaks further comprising setting said postage correction rate equal to zero if said first difference is negative and setting said dimension based charge equal to zero if said second difference is negative.

21. A method according to claim 1, wherein accessing a first rate table further comprises:
receiving a first class of service used to originally process said one or more pieces of residual mail; and
accessing a first rate table corresponding to the received first class of service.

22. A method according to claim 21, wherein accessing a second rate table further comprises:
receiving a second class of service to which a postage value originally applied to each of said one or more pieces of residual mail is to be corrected; and
accessing a second rate table corresponding to the received second class of service.

23. A mail processing system according to claim 10, wherein said first rate table and said second rate table are stored in said memory.
